(19) United States
(12) Patent Application Publication
(10) Pub. No.: US 2025/0244359 A1
(43) Pub. Date: Jul. 31, 2025

(54) Method and Apparatus of Magnetic Property Measurement Using an AFM Operating in a Force Mapping AFM Mode

(71) Applicant: Bruker Nano, Inc., Santa Barbara, CA (US)

(72) Inventors: Shuiqing Hu, Goleta, CA (US); Peter De Wolf, Saint Remeze (FR); Rakesh Poddar, Camarillo, CA (US)

(21) Appl. No.: 19/043,245

(22) Filed: Jan. 31, 2025

Related U.S. Application Data
(60) Provisional application No. 63/627,686, filed on Jan. 31, 2024.

(51) Int. Cl. G01Q 60/38

(52) U.S. Cl. CPC G01Q 60/38

(57) ABSTRACT

An apparatus and method of collecting topography, mechanical property data and magnetic and electrical property data with an atomic force microscope (AFM) in either a single pass or a dual pass operation, hereinafter sometimes referred to Peak Force MFM/Peak Force EFM (or PF-MFM/PF-EFM). PFT mode is preferably employed thus allowing the use of a wide range of probes, one benefit of which is to enhance the sensitivity of magnetic and electrical property measurement. Other force mapping/transient modes such as force volume mode may be used as an alternative, with or without gated probe/sample excitation.

### CROSS-REFERENCE TO RELATED APPLICATIONS

This application claims priority under 35 U.S.C. § 1.119 (e) to U.S. Provisional Patent Application No. 63/627,686, filed on 31 Jan. 2024. The subject matter of this application is hereby incorporated by reference in its entirety.

### BACKGROUND OF THE INVENTION

### Field of the Invention

The preferred embodiments are directed to scanning probe microscopy methods and apparatus, and more particularly, using an atomic force microscope (AFM) to collect topography, mechanical and magnetic/electrical sample property data, preferably using a force mapping mode such as peak force tapping mode (PFT mode) AFM, and Magnetic or Electric Force Microscopy (MFM/EFM), respectively.

### Description of Related Art

Scanning probe microscopes (SPMs), such as the atomic force microscope (AFM), are devices which typically employ a probe having a tip and which cause the tip to interact with the surface of a sample with low forces to characterize the surface down to atomic dimensions. Generally, the probe is introduced to a surface of a sample to detect changes in the characteristics of a sample. By providing relative scanning movement between the tip and the sample, surface characteristic data can be acquired over a particular region of the sample, and a corresponding map of the sample can be generated.

A typical AFM system is shown schematically in FIG. 1. An AFM 10 employs a probe device 12 including a probe 14 having a cantilever 15 extending from a base 19. A scanner 24 generates relative motion between the probe 14 and a sample 22 while the probe-sample interaction is measured. In this way, images or other measurements of the sample can be obtained. Scanner 24 is typically comprised of one or more actuators that usually generate motion in three mutually orthogonal directions (XYZ). Often, scanner 24 is a single integrated unit that includes one or more actuators to move either the sample or the probe in all three axes, for example, a piezoelectric tube actuator. Alternatively, the scanner may be a conceptual or physical combination of multiple separate actuators. Some AFMs separate the scanner into multiple components, for example an XY actuator that moves the sample and a separate Z-actuator that moves the probe. The instrument is thus capable of creating relative motion between the probe and the sample while measuring the topography or some other property of the sample as described, e.g., in Hansma et al. U.S. Pat. No. RE 34,489; Elings et al. U.S. Pat. No. 5,266,801; and Elings et al. U.S. Pat. No. 5,412,980.

In a common configuration, probe 14 is often coupled to an oscillating actuator or drive 19 that is used to drive probe 14 to oscillate at or near a resonant frequency of cantilever 15. Alternative arrangements measure the deflection, torsion, or other characteristics of cantilever 15. Probe 14 is often a microfabricated cantilever with an integrated tip 17.

Commonly, an electronic signal is applied from an AC signal source 18 under control of an SPM controller 20 to cause actuator 16 (or alternatively scanner 24) to drive the probe 14 to oscillate. The probe-sample interaction is typically controlled via feedback by controller 20. Notably, the actuator 16 may be coupled to the scanner 24 and probe 14 but may be formed integrally with the cantilever 15 of probe 14 as part of a self-actuated cantilever/probe.

As a selected probe 14 is oscillated, it is brought into contact with sample 22 as sample characteristics are monitored by detecting changes in one or more characteristics of the oscillation of probe 14, as described above. In this regard, a deflection detection apparatus 25 is typically employed to direct a beam towards the backside of probe 14, the beam then being reflected towards a detector 26, such as a four quadrant photodetector. The deflection detector is often an optical lever system such as described in Hansma et al. U.S. Pat. No. RE 34,489, but may be some other deflection detector such as strain gauges, capacitance sensors, interferometric detection, etc. The sensing light source of apparatus 25 is typically a laser, often a visible or infrared laser diode. As the beam translates across detector 26, appropriate signals are processed by a signal processing block 28 (e.g., to determine the RMS deflection of probe 14). The interaction signal (e.g., deflection) is then transmitted to controller 20, which processes the signals to determine changes in the oscillation of probe 14. In general, controller 20 determines an error at Block 30, then generates control signals (e.g., using a PI gain control Block 32) to maintain a relatively constant interaction between the tip and sample (or deflection of the lever 15), typically to maintain a setpoint characteristic of the oscillation of probe 14. The control signals are typically amplified by a high voltage amplifier 34 prior to, for example, driving scanner 24. For example, controller 20 is often used to maintain the oscillation amplitude at a setpoint value, A_{S}, to insure a generally constant force between the tip and sample. Alternatively, a setpoint phase or frequency may be used. Controller 20 is also referred to generally as feedback where the control effort is to maintain a constant target value defined by the setpoint.

A workstation 40 is also provided, in the controller 20 and/or in a separate controller or system of connected or stand-alone controllers, which receives the collected data from the controller 20 and manipulates the data obtained during scanning to perform data manipulation operations such as point selection, curve fitting, and distance determining operations. The workstation can store the resulting information in memory, use it for additional calculations, and/or display it on a suitable monitor.

AFMs may be designed to operate in a variety of modes, including contact mode and oscillating mode. Operation is accomplished by moving the sample and/or the probe assembly up and down relatively perpendicular to the surface of the sample in response to a deflection of the cantilever of the probe assembly as it is scanned across the surface. Scanning typically occurs in an “x-y” plane that is at least generally parallel to the surface of the sample, and the vertical movement occurs in the “z” direction that is perpendicular to the x-y plane. Note that many samples have roughness, curvature and tilt that deviate from a flat plane, hence the use of the term “generally parallel.” In this way, the data associated with this vertical motion can be stored and then used to construct an image of the sample surface corresponding to the sample characteristic being measured, e.g., surface topography. In one practical mode of AFM operation, known as TappingMode™ AFM (TappingMode™ is a trademark of the present assignee), the tip is oscillated at or near a resonant frequency of the associated cantilever of the probe, or harmonic thereof. A feedback loop attempts to keep the amplitude of this oscillation constant to minimize the “tracking force,” i.e., the force resulting from tip/sample interaction, typically by controlling tip-sample separation. Alternative feedback arrangements monitor other probe oscillation characteristics to keep, for example, the phase or oscillation frequency constant. As in contact mode, these feedback signals are then collected, stored and used as data to characterize the sample.

Regardless of their mode of operation, AFMs can obtain resolution down to the atomic level on a wide variety of insulating or conductive surfaces in air, liquid or vacuum by using piezoelectric scanners, optical lever deflection detectors, and very small cantilevers fabricated using photolithographic techniques. Because of their resolution and versatility, AFMs are important measurement devices in many diverse fields ranging from semiconductor manufacturing to biological research. Note that “SPM” and the acronyms for the specific types of SPMs, may be used herein to refer to either the microscope apparatus or the associated technique, e.g., “atomic force microscopy.”

Kelvin-Probe Force Microscopy (KPFM), also known as Surface Potential Microscopy (SPoM), and Surface Electric Potential Microscopy (SEPM), have been important tools for electrical measurements using scanning probe microscopes (SPMs), such as AFMs, for many years.

Fundamentally, KPFM is a combination of atomic force microscopy (AFM) and Kelvin probe technique. Kelvin probe technique was designed to measure the contact potential difference (CPD) between an AFM probe and a sample surface when the two are brought close to one another. The CPD depends largely on the work function difference between the two materials. In this regard, the work function of a sample under test can be deduced if the work function of the probe is calibrated against a sample having a well-defined work function. Traditional Kelvin probe technique has a high sensitivity for potential measurements but offers poor spatial resolution. Improvements to KPFM have been developed over the years, including that shown and described in U.S. Pat. No. 9,869,694.

The study of magnetic and electrical forces at the nanometer scale has also long been of interest to investigators of magnetic recording materials, superconductors, and magnetic nanoparticles, among others. Magnetic Force Microscopy (MFM) is a form of atomic force microscopy, in which magnetic forces acting on a sharp, magnetized tip, by a magnetized sample, are measured. Electric Force Microscopy (EFM) is a form of atomic force microscopy, in which electrical forces acting on a sharp, conductive/metallized tip, by a sample, are measured. During this measurement the tip is lifted off the surface in order to separate the long-range magnetic forces from the short-range atomic forces between tip and sample. These are secondary imaging modes to standard AFM derived from TappingMode™ that maps the magnetic force gradient above the sample surface while simultaneously obtaining topographical data.

MFM/EFM most often rely on a patented two-pass technique, LiftMode™. The system alternates scan lines at the sample surface and at a designated lift height above the sample surface, to separately measure topography and electrical/magnetic force, respectively. MFM/EFM can be used to image both naturally occurring and deliberately written domain structures in magnetic materials. As consumer electronics become sleeker and smaller, they also increase in computing power and data storage capacity. Electronics development scientists often need to map the electronic characteristics of complex, sub-micron electrical materials and assemblies. EFM is used for electrical failure analysis, detecting trapped charges, mapping electric polarization, and performing electrical read/write, among other electrical-based applications.

Known magnetic force microscopy and electric force microscopy operate in a steady-state force mode where a probe, including a cantilever and a tip, with a thin magnetic coating is driven at its resonance frequency, typically in the tens or hundreds of kilohertz (this mode is also referred to as TappingMode™). Typically, the tip is coated, and sometimes it is the only part of the probe which is coated. These probes are typically inexpensive. MFM/EFM may map the phase, amplitude and frequency of the oscillating cantilever as it passes over at a prescribed height (1^{st} pass) over the sample. A repulsive magnetic force gradient (or electrical force gradient distribution above the sample surface in EFM) will cause the resonance curve to shift to a higher frequency, accompanied by an increase in phase shift. Conversely, an attractive magnetic force gradient results in the resonance curve shifting to a lower frequency, accompanied by a decrease in phase shift. The advantages of MFM/EFM operation in TappingMode™ are lower noise and higher resolution. The tip-sample distance is important for optimizing MFM operation.

Because TappingMode™ is a steady-state control mode, precise control of the tip-sample force, and thus distance, is not ideal. Moreover, because the stray magnetic and electrical fields from the sample can affect the electrical/magnetic state of the tip, and vice versa, interpretation of the EFM/MFM measurement is not straightforward. For instance, the geometry of the tip magnetization must be known for quantitative analysis.

EFM/MFM phase detection sensitivity is given by, Δφ˜Q/k·∂F/∂z. A conventional EFM/MFM probe may have a spring constant (k) of about 5 N/m, a resonant frequency, fᵣₑₛ, of about 180 kHz, a Q factor of approximately 400, yield a sensitivity (Δφ) of about 80. Significant improvement was desired.

In sum, the microscopy field was in need of an improved instrument capable of fast, high sensitivity magnetic and electrical property measurement, with the ability to measure and correlate magnetic, electrical, topography, and mechanical sample property measurement at each data acquisition location.

### SUMMARY OF THE INVENTION

The preferred embodiments are directed to high performance MFM and EFM. More particularly, the invention is directed to an AFM that combines topography and mechanical property measurement of a sample, e.g., on the nanoscale, with the capability to characterize magnetic/electrical properties using specially designed probes. The preferred embodiments make it possible to measure mechanical properties and magnetic/electrical properties of a sample at the same time, with improved accuracy/resolution, at the nanometer scale, and associate that magnetic/electrical property data with more credible topography and mechanical property information concerning the sample.

By employing an innovative force mapping mode of AFM operation, Peak Force Tapping® mode (PFT mode) is often preferred but others are contemplated too, such as QI Mode™ and Force Volume Mode™ (trademarks of Bruker Nano, Inc., of Santa Barbara, CA), the exemplary embodiments are able to achieve higher sensitivity factor as well as accuracy/repeatability improvements over known systems, primarily due to PFT mode's ability to support probes having higher sensitivity factor. The new system is herein sometimes referred to as Peak Force MFM, or PF-MFM, or Peak Force EFM, or PF-EFM. The exemplary embodiments combine the mechanical and magnetic capabilities of AFM to substantially fully characterize samples on, e.g., the nanometer scale. While PFT methods and apparatus operate to gather data concerning mechanical properties of a sample and MFM/EFM methods and apparatus operate to gather data concerning magnetic and electrical properties of a sample, the preferred embodiments make AFM more powerful by integrating the two. Not only does the result improve user efficiency, but also allows in situ correlation of mechanical properties and electrical properties for very small features (i.e., high resolution), thus providing new information regarding a material's characteristics and performance.

In one of the preferred embodiments, a method for measuring multiple properties of a sample includes providing an atomic force microscope (AFM) including a probe having a tip. The method then operates the AFM in an oscillating force mapping mode to cause the probe to oscillate and interact with the sample in one of a one pass procedure and a two pass procedure. Thereafter, topographic and mechanical property data corresponding to the sample is obtained by detecting at least one characteristic of oscillation of the probe. The method then collects at least one of magnetic property data and electrical property data corresponding to the sample with the probe using at least one of an EFM algorithm and an MFM algorithm, each of which using, for example, a mechanical excitation source to drive the probe or sample and excite a probe oscillation, preferably at resonance.

According to an aspect of this embodiment, the force mapping mode is Peak Force Tapping mode.

In another aspect of this embodiment, the algorithm includes gating detection of the probe oscillation. In one example, the gating step is performed at a hold position of tip-sample separation. The hold position may correspond to zero probe-sample separation.

According to another aspect of this embodiment, the excited oscillation is provided by a source of mechanical excitation at a resonance of the probe.

According to a further aspect of this embodiment, the method includes acquiring at least one of topography and mechanical property data during the detecting step. Moreover, the mechanical property data includes at least one of elasticity, stiffness, plasticity, adhesion, viscoelasticity and hardness.

In a further aspect of this embodiment, the second pass uses gated excitation of the sample and/or probe. In addition, the magnetic excitation may be a square wave and is executed during the approach and snap-to-contact portion of the tip-sample force/deflection curve.

According to another aspect of this embodiment, the probe has a sensitivity factor (Q/k) greater than 40. Combining PFT AFM mode and MFM/EFM according to the preferred embodiments may also realize sensitivity factors greater than 100, and even greater than 200.

According to a further aspect of this embodiment, a combination of the cantilever and the tip is made of a single homogeneous material. Alternatively, or in addition, the tip may be one of entirely magnetic and coated on at least one of its sides with a magnetic material. The magnetic material may be a Co-Cr coating of a selected thickness, or another suitable material, or thickness.

According to another preferred embodiment, a method for measuring multiple properties of a sample includes providing an atomic force microscope (AFM) including a probe having a cantilever and a tip, with the tip being at least one of magnetically and electrically active. The method then operates the AFM to cause the probe to interact with the sample in a two pass procedure. Next, detecting, during a first pass of the two pass procedure, a surface of the sample by operating the AFM in a force mapping mode is provided. Then method then collects, during a second pass of the two pass procedure, at least one of magnetic and electrical property data corresponding to the sample with the probe having a magnetic tip.

In a further aspect of this embodiment, at least one of topography and mechanical property data during the detecting step is acquired. For example, the acquiring step may include collecting mechanical property data and the mechanical property data includes at least one of elasticity, stiffness, plasticity, adhesion, viscoelasticity and hardness.

According to another aspect of this embodiment, the second pass uses gated detection of the oscillation of the probe. The gated detection can occur at strategic points of the tip-sample separation; for example, detection may be performed during the approach and snap-to-contact portion of the tip-sample force curve.

According to a further aspect of this embodiment, the probe has a sensitivity factor (Q/k) greater than 40, and can be greater than 200. The probe may be magnetic, and in one case include a magnetic Co-Cr coating disposed on the tip. Moreover, the force mapping mode may be one of Peak Force Tapping® (PFT), QI Mode™ and Force Volume™ Mode.

In another preferred embodiment, an atomic force microscope (AFM) for performing magnetic force microscopy includes a probe having a tip, with the tip being one of a group including a) entirely magnetic, and b) coated with a magnetic material on at least one of a plurality of sides of the tip. A scanner provides relative scanning motion between the probe and a sample causing the probe to interact with the sample. And a controller controls the AFM in an oscillating force mapping mode to collect at least one of topography data and mechanical property data, and to collect at least one of magnetic data and electric property data with the probe using one of a group including a single pass procedure and a two pass procedure.

In another aspect of this embodiment, the controller controls the AFM in PFT mode using a two pass procedure known as LiftMode™, and the topography data collected in a first pass of the two pass procedure is used in the second pass, in which an MFM or EFM algorithm is employed.

According to a further aspect of this embodiment, the probe has a spring constant less than 1 N/m. Moreover, the tip may be coated on at least one of its sides with a magnetic material such as a Co—Cr coating.

These and other features and advantages of the invention will become apparent to those skilled in the art from the following detailed description and the accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Preferred exemplary embodiments of the invention are illustrated in the accompanying drawings in which like reference numerals represent like parts throughout, and in which:

FIG. 1 is a schematic illustration of a prior art atomic force microscope (AFM);

FIG. 2 is a schematic illustration of a preferred embodiment of the invention showing an AFM configured for MFM/EFM operation using PFT mode to collect topography, mechanical property and magnetic/electrical property data;

FIG. 3 is a schematic illustration of an exemplary embodiment of the AFM of FIG. 2, using a two-pass technique, and no PLL;

FIG. 4 is a schematic illustration of an exemplary embodiment of the AFM of FIG. 2, using a two-pass technique, and a PLL;

FIG. 5 is a schematic illustration of an embodiment of the AFM of FIG. 2, using a two-pass technique and including a KPFM loop; and

FIG. 6 is a flow chart illustrating a two-pass MFM/EFM method according to an exemplary embodiment;

FIG. 7 is a flow chart illustrating an alternative MFM/EFM method according to an exemplary embodiment; and

FIGS. 8A and 8B are a series of plots illustrating a single-pass MFM/EFM method of a preferred embodiment, with gated MFM/EFM measurement.

### DETAILED DESCRIPTION OF THE PREFERRED EMBODIMENTS

The benefits of force mapping modes such as PFT mode AFM are numerous. Most noteworthy is their ability to perform simultaneous quantitative mechanical property mapping and topographical imaging. Moreover, their ability to be effective using a wide range of cantilevers having varying properties (spring constant, resonant frequency and quality factor) allows for probe selection most suited to MFM/EFM operation, which itself has strict requirements for the probes employed. EFM/MFM probes MFM have a sensitivity determined by the quality factor and spring constant of the cantilever, through the Q/k relationship. The probes must also be able to hold a magnetic coating for MFM, electric for EFM. It is the object of this invention to combine PFT mode AFM with MFM/EFM, using a probe particularly suited for sensitive, high resolution MFM and EFM. The system offers simultaneous surface topography, mechanical properties, and magnetic/electrical property mapping with enhanced sensitivity. The implementation and benefits will be outlined below.

Peak Force Tapping mode (PFT mode), provides a solution to high speed topography and force volume measurement, as well as quantitative mechanical property mapping. With the tip driven in and out of contact with the surface at multi-kilohertz frequency, the tip's position and mechanical response (bending and thus deflection) are recorded. The recorded data resembles conventional force curve data and are thus analyzed based on a well-defined model. Mechanical properties, such as elasticity, plasticity, adhesion, etc., can be derived for the localized area under the probe's apex. It is notable that the process to capture data and do the analysis is done at very high speed (sub-milliseconds) and therefore quantitative mapping with high spatial resolution is achieved, in real time during typical AFM topographic imaging.

AFM Peak Force Tapping (PFT) mode is described, inter alia, in U.S. Pat. Nos. 8,646,109 and 8,739,309, entitled Method and Apparatus of Operating a Scanning Probe Microscope and U.S. Pat. No. 8,650,660, entitled Method and Apparatus of Using Peak Force Tapping Mode to Measure Physical Properties of a Sample. Using PFT Mode, the AFM drives the cantilever at a frequency far lower than the resonant frequency, contrary to TappingMode™, allowing essentially instantaneous force monitoring and control. Sample imaging and mechanical property mapping are achieved with improved resolution and high sample throughput, with operation suitable in air, fluid and vacuum environments. Moreover, PFT mode facilitates ease-of-use operation, where an algorithm may be employed to automatically adjust the AFM imaging feedback gain, force setpoint and scan rate based on a predetermined noise threshold.

Though PFT mode provides substantial advantages regarding mechanical property characterization on the nanometer scale, it is unable to provide all data some users need. For instance, characterization of magnetic and electrical properties of the sample may be desired, including associating one or more magnetic/electrical properties with one or more corresponding mechanical property characteristics (along with topography) at each data collection point.

As discussed previously, Magnetic Force Microscopy (MFM) and Electrical Force Microscopy (EFM) are established methods of using AFM to measure some electrical and magnetic properties, respectively. Traditional feedback or LiftMode™ is used to keep the distance between the probe and the sample surface constant. However, traditional EFM/MFM does not give information about a material's mechanical properties.

MFM/EFM techniques using periodic excitations can benefit from operating the AFM so that the response of interest occurs at or near a cantilever resonance. At resonance, the cantilever's amplitude response

$$isx = Q \frac{F}{k} ,$$

i.e., enhanced by a factor Q over the steady-state result derived from Hook's Law,

$$x = \frac{F}{k} .$$

Here, F and x are the amplitudes of the sinusoidal force on the cantilever and the resulting displacement, respectively. The cantilever's spring constant is k and Q is the quality factor of its assumed resonance. The best-case signal-to-noise ratio (S/N) at resonance of the detection of the displacement, x, can be estimated from the thermal noise using the equipartition theorem: k_{B}T/2=k(Δx)²/2, where k_{B} is the Boltzmann constant, T is the absolute temperature, and Δx is the expected noise amplitude. Therefore,

$$\frac{x}{Δ x} = \frac{Q}{\sqrt{k}} \frac{F}{\sqrt{{k}_{B} T}} .$$

These relations reveal that higher Q and lower k will benefit EFM/MFM sensitivity and detection limit (assuming at S/N=1).

The following analysis helps understand how the characteristics of the cantilever affect EFM/MFM sensitivity. For an AFM probe/cantilever with a spring constant k and an effective mass m, its mechanical resonance frequency is:

$$f = \frac{1}{2 π} \sqrt{\frac{k}{m}}$$

An external long range force such as electrostatic (or magnetic) force with gradient

$$\frac{\partial {F}_{el}}{\partial z}$$

gives rise to a frequency shift:

$$Δ f = \frac{f}{2 k} Δ k = \frac{f}{2} \frac{\partial {F}_{el}}{\partial z}$$

The frequency shift corresponds to a phase shift, which is commonly used in MFM/EFM detection. In a harmonic oscillator, a resonance frequency change across its bandwidth^{ω}/Q corresponds to a phase shift of 90°, therefore,

$$\begin{matrix}Δφ = 90 \frac{Δ ω}{ω / Q} = 90 Q \frac{Δ ω}{ω} \\ = 90 Q \frac{Δ k}{2 k} = 45 \frac{Q}{k} \frac{\partial {F}_{el}}{\partial z}\end{matrix}$$

For a given electric force gradient, a bigger sensitivity factor Q/k of the cantilever leads to a bigger phase change, and thus higher measurement sensitivity for MFM/EFM.

From these expressions it is clear that a high Q and low k is desirable for sensitive MFM/EFM measurements.

MFM under vacuum (absence of air damping) enjoys high sensitivity thanks to the high Q (usually 2-3 orders of magnitude higher than in air). However, for SPM operation in air, which is one of the major advantages of SPM over other high-resolution microscopes such as SEM, potential Q values are limited. Hence, the lowest possible spring constant is important for sensitive MFM/EFM in air. For practical reasons, standard TappingMode SPM operation requires using probes having relatively high spring constants for reliable operation (e.g., the probe tip may stick to the surface of the sample), and not too high a Q value to attain a bandwidth that allows a reasonably fast scan rate. Therefore, MFM/EFM sensitivity is necessarily limited.

PFT mode AFM (as well as QI Mode and Force Volume Mode) lifts the restrictions associated with intermittent-contact mode (TappingMode™). As a result, probes having a wide range of characteristics can be used to enhance MFM detection sensitivity. For instance, typical MFM/EFM probes have a sensitivity factor Q/k of around 40. Now, probes having a corresponding Q/k ratio above 40, as well as above 100 and even 200, can be employed with the present preferred embodiments.

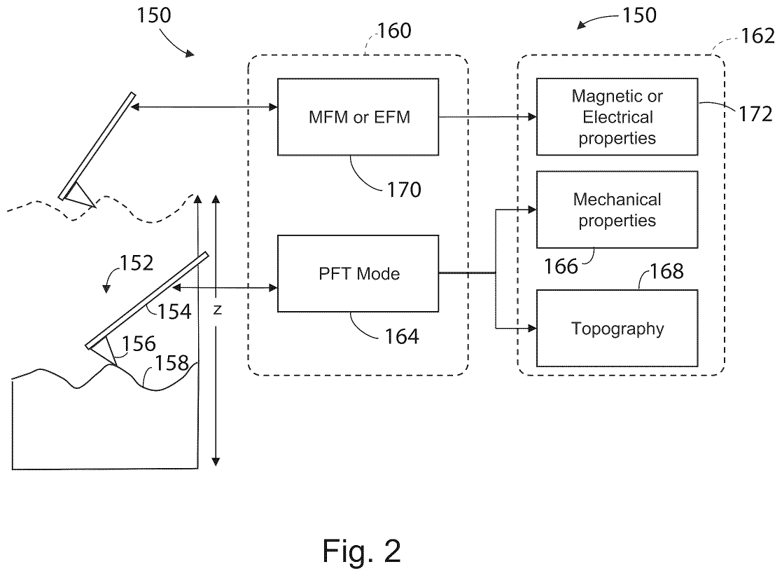

Referring to FIG. 2, a combination of peak force tapping technology in an MFM/EFM system is shown as an MFM/EFM instrument 150 including a control block 160 and a data collection unit 162. In one embodiment, the integration of these two state-of-the-art techniques is realized through LiftMode™ operation, i.e., a two pass procedure. Note that herein the terms “single pass” procedure and “two (or dual) pass” procedure are used. These terms refer to the relative scanning motion between the probe and the sample (in XY) during AFM operation being performed either once or twice on the same scan line in a raster scan (e.g., LiftMode™)

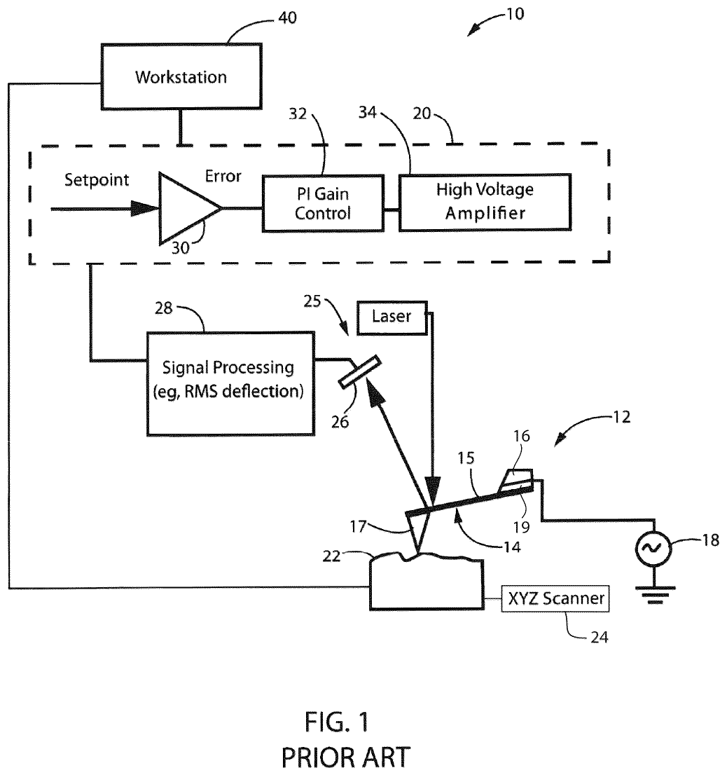

In FIG. 2, during a first pass, PFT operating mode is employed to detect/determine the sample surface which often includes acquiring accurate surface topographical information, as well as mechanical properties (e.g., via force curves at each X-Y location). More particularly, Peak Force EFM (or PF-EFM) and Peak Force MFM (or PF-MFM) 150 includes a probe 152 defining a cantilever 154 supporting a tip 156 at its distal end. Probe 152 is scanned across the surface of a sample 158 while the probe is oscillated generally at a multi-kilohertz off-resonance frequency. The deflection of the lever 154 (detected, for example, by an optical beam-bounce technique employing a quadrant photodetector) is monitored and sent to a PFT mode control block 164 which operates to keep the tip-sample force at the PFT setpoint. As understood, it is the control provided by PFT mode that may yield signals indicative of mechanical properties of the sample surface, as well as topography. This data is stored in data collection unit 162 depicted in FIG. 1 as blocks 166 and 168, respectively.

Then, once the surface topography is known at each data collection point (X, Y) along one scan line on the sample surface, the tip preferably is lifted up some constant distance “Z” from either the sample surface or a surface of the sample holder to follow the surface profile on a second pass/scan of sample surface 158 during which a magnetic or EFM measurement is made using an MFM or EFM algorithm 170. Note that if the sample surface is merely determined in the first pass, a simple lift at a user-selected distance may be employed in the second pass of the scan, i.e., topography data, though preferred, need not be collected and used in the second pass; rather, the lift and second pass may be performed regardless of whether the topography is known from the first pass. The magnetic property, electrical, mechanical and topography information can then be combined to render a composite view of different surface features of sample 158.

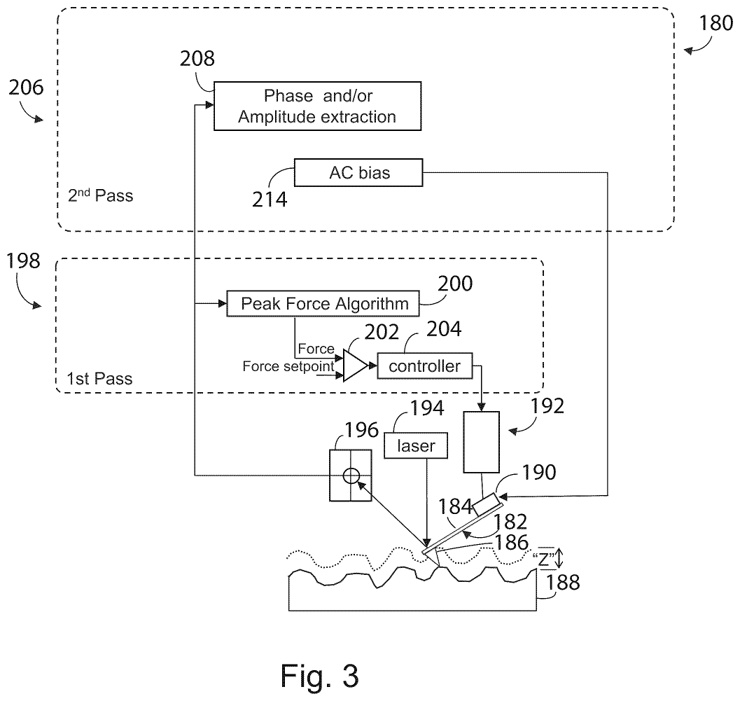

Referring next to FIG. 3, a PF-MFM/EFM system 180 includes PFT mode AFM hardware including a probe 182 defining a cantilever 184 supporting a tip 186. In this two-pass embodiment of the present invention, an AC bias 214 is applied to an actuator 190 coupled to probe 182 to oscillate probe 182 at a multi-kilohertz frequency during a first pass (governed by control block 198; control block 206 is the MFM/EFM control block). Tip 186 of EFM/MFM system 180 is thereby caused to interact with the surface of sample 188. As probe tip 186 interacts with the surface of sample 188, the deflection of probe 182 is monitored by directing a laser beam from a source 194 toward the backside of lever 184, which is then reflected to a detector 196, such as a quadrant photo detector 196. Detector 196 transmits this deflection signal to a peak force algorithm block 200. Peak force algorithm block 200 generates a signal indicative of the force corresponding to the detected deflection, and that force signal is compared to a force setpoint at block 202. A PFT mode controller 204 then determines an appropriate control signal “S” based on the detected force which is transmitted to an actuator 192 (e.g., a piezoelectric XYZ tube) to appropriately position probe 182 in “Z.” At each X-Y location of the sample, the interaction is captured to generate a force curve from which several mechanical properties of the sample can be derived. Note that EFM/MFM block 206 is not operational during the first pass in which the AC bias (between the probe 182 and the sample 188) is maintained (e.g., set at zero).

PFT mode can be performed automatically, in which at least one of the feedback gain, scan rate, and peak force setpoint can be set by the system software. Moreover, though preferred, mechanical property mapping need not be included. When it is, PF-MFM or PF-EFM provides simultaneous (with topography imaging) property mapping of at least one of adhesion, elasticity, hardness, plasticity, surface deformation and energy dissipation, for example.

During a second pass over the sample scan line, probe 182 is “lifted” a fixed distance “z” (usually a few nanometers, up to a few hundred nanometers) from the surface. An AC bias at frequency f₁ is applied to the tapping piezoelectric actuator 190 which oscillates the probe at or near its mechanical resonance frequency f₁. The EFM/MFM loop 206 extracts amplitude and/or phase. In this embodiment, no phase locked loop (PLL) is used.

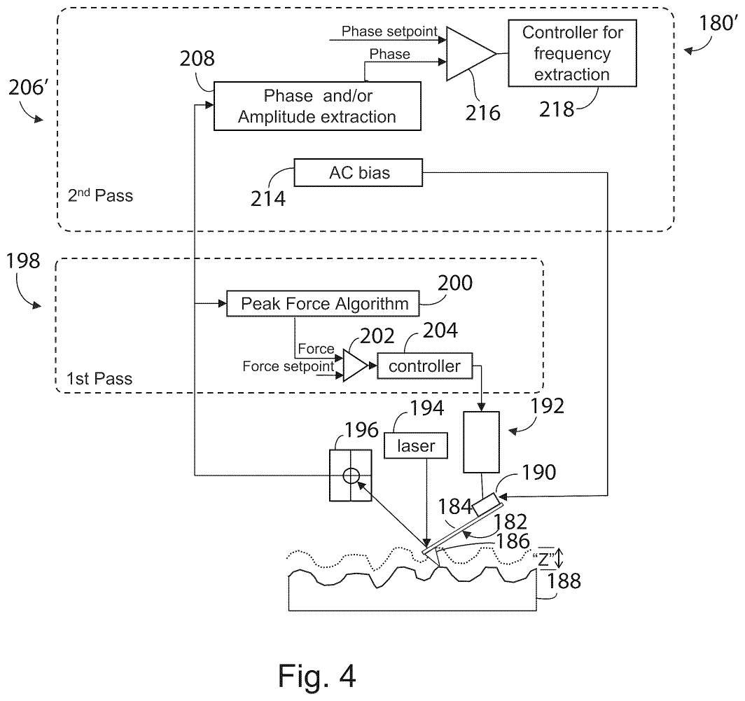

In another embodiment of the invention, MFM/EFM system 180′ show in FIG. 4, a phase locked loop is utilized. The PFT control block 198 is the same, but in this case the MFM/EFM control block 206′ compares a phase setpoint to the extracted phase during the second pass in Block 216. A controller 218 is provided to maintain the setpoint phase.

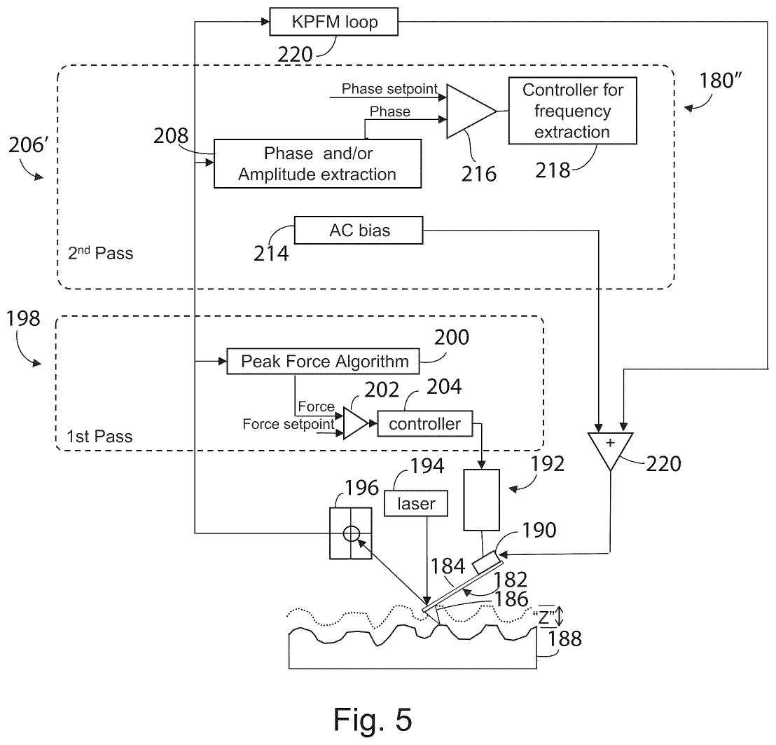

In a further embodiment (shown in FIG. 5), system 180″ includes a KPFM loop 220. KPFM loop 220 provides electrical measurements as known in the art (see, e.g., U.S. Pat. No. 9,869,694 referenced above). In this case, a mechanical or electrical drive 220 is provided depending on the measurement.

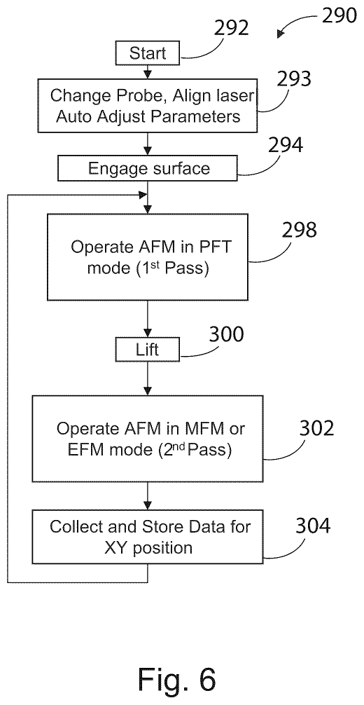

A method 290 of operating the Peak Force MFM/EFM according to a preferred embodiment is shown in FIG. 6. In this two pass approach/procedure, after an initialization and start up step at Block 292, the laser for the optical detection set-up is aligned with the probe and the method auto adjusts the MFM operating parameters in Block 293. This may include changing the probe, aligning the laser and auto adjusting the MFM/EFM parameters. For example, the user may determine the cantilever resonance frequency through a tuning step (can be a thermal noise analysis, driving with a frequency sweep signal, etc.), and then set the drive amplitude as a function of a preset amplitude setpoint.

Method 290 then operates to engage surface at Block 294, for example, using a rapid engage algorithm such as that shown and described in U.S. Pat. No. 7,665,349. Relative scanning motion between the probe and sample is initiated and AFM is operated in PFT mode as part of a first pass in Block 298. As part of this 1^{st} pass in Block 298, the bias voltage is set to zero. Note that this is optional, and typically not required for MFM.

Once the sample surface data is acquired, the topography is known. This could be a single XY position (pixel-by-pixel), or most often, along a line of several XY positions (i.e., scan line), the typical method used in LiftMode™. Then, the probe is lifted off the surface a selected distance in Block 300. As stated previously, the distance the probe is lifted off the surface can be user-selected independent of the sample topography; for example, in the case in which topography data is not acquired and the surface is simply sensed in the first pass. Then, the PF-MFM loop is operated as part of a second pass of relative motion between the sample and probe in Block 302. As part of this 2^{nd} pass, the bias voltage is applied. MFM/EFM data can then be collected and stored according to the above described techniques in Block 304. XY position here is a general term meaning that the technique may be employed pixel-by-pixel, or typically, scan lien-by-scan line.

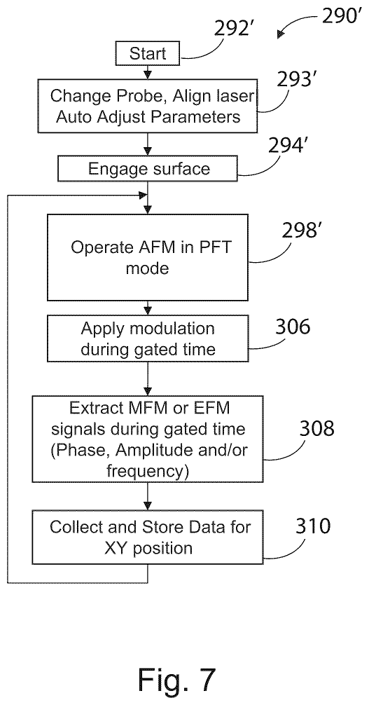

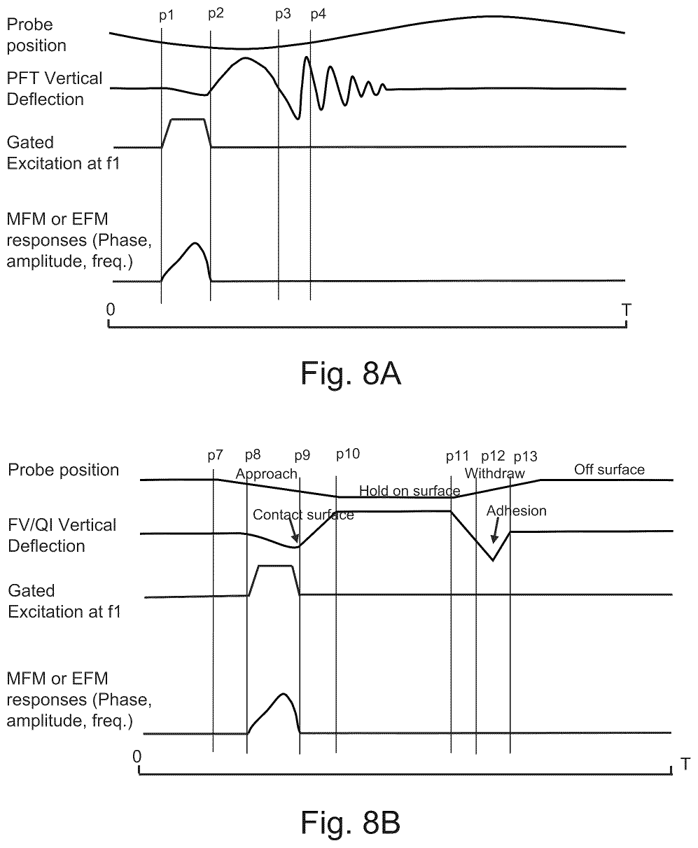

FIG. 7 illustrates a preferred embodiment in which a single pass is employed to collect topography, mechanical and magnetic/electric property data concerning the sample surface. More particularly, a method 290′ includes a start-up and initialization step at block 292′. The laser for the optical detection set-up is aligned with the probe and the method auto adjusts the MFM operating parameters in Block 293′. This may include changing the probe, aligning the laser and auto adjusting the MFM/EFM parameters. Thereafter, the probe and sample are engaged with one another in block 294′. Relative scanning motion between the probe and sample is initiated and AFM is operated in PFT mode as part of a first pass in Block 298′. Next, in Block 306, gated modulation is applied (see FIG. 8). Method 290′ extracts MFM or EFM signals during the gated time (phase, amplitude and/or frequency) in Block 308. Both the MFM/EFM algorithm and the PFT algorithm are operated substantially simultaneously to acquire topography, mechanical property and magnetic/electrical property data in a single pass. The data acquired in block 308 is then collected and stored for each XY position in block 310.

FIGS. 8A and 8B are a series of plots illustrating an embodiment using gated modulation of the method of FIG. 7. The oscillating PFT probe position is shown at the top, and the corresponding PFT vertical deflection follows immediately below in FIG. 8A. Typically a mechanical excitation of the probe or sample is provided (e.g., with a square wave) at a cantilever resonance, as in TappingMode MFM/EFM. Detection of the response can be gated or continuous, for example, during the approach and snap-to-contact portion of the shown force/deflection curve (p1-p2). In an alternate force mapping AFM mode to the four PFT curves shown in FIG. 8A (e.g., force volume or QI), the probe is driven other than sinusoidally, with the positions shown, including the option for a “hold” (probe-sample distance or separation held in time period p10-p11, FIG. 8B). Excitation can be gated to any of the segments shown (here it is the “approach” between p8 and p9). MFM or EFM information is thereafter extracted with other AFM imaging and mechanical property information.

FIGS. 8A and 8B are examples. Other implementations of single-pass Peakforce MFM and Peakforce EFM are contemplated and possible. In single-pass Peakforce MFM/EFM, the excitation—creating probe oscillations—can be continuous or gated. The detection is gated, with flexibility in the defined (e.g., by the AFM operator) position and duration of the gate. This flexibility allows one to perform MFM/EFM detection—for example—at different height positions relative to the sample surface. In turn, this can relate to the spatial resolution obtainable; to wit, generally, measurements performed closer to the surface exhibit higher spatial resolution.

Notably, probe design is important. For example, a single tip side can be coated rather than all sides of the tip pyramid. Reducing coating thickness can also be employed with a cantilever having higher sensitivity, as described above. Thinner coatings can also be employed for lower moment, which in turn can lead to higher spatial resolution, and/or the capability to measure low moment magnetic samples where a regular moment (not low moment) probe could alter the sample's magnetic domains thereby preventing one to perform MFM imaging. Notably, coatings such as a Co—Cr coating may be employed. Ultra-low-moment tips may also be employed for samples which can easily be magnetized/de-magnetized by the presence of the tip.

To optimize the PF-MFM or PF-EFM system, one or more of the following can be used:
Select a cantilever with spring constant k<1 N/m
Select smaller cantilevers for further sensitivity enhancements
Use a single pass method, whereby the magnetic/electric detection is performed during time gated periods
Perform KPFM to compensate for electrical variations caused by contact potential differences (hereby deconvoluting electrical from magnetic information)
Auto-adjust parameters to define MFM/EFM resonance settings (similar as applied in the PF-KPFM method) prior to collecting data.
Use an external stimulus such as external magnetic fields, during the magnetic/electric measurements.

### Advantages

The preferred embodiments offer simultaneous acquisition of surface topography, mechanical properties, and mechanical/electrical property mapping. PFT mode AFM's ability to use cantilevers having properties (spring constant, resonant frequency and quality factor) over a wide range (Q/k over 40 is desired but over 100, and even over 200, is possible) can be used to the advantage of PF-MFM or PF-EFM measurement. For instance, probes with low spring constant and high quality factors that are restricted for Tapping mode operation, now can be used to enhance MFM detection sensitivity.

Advantages over standard MFM/EFM:
One can use more sensitive cantilevers (scales with Q & 1/k):

$$Δφ \sim \frac{Q}{k} \cdot \frac{\partial F}{\partial z}$$

Higher sensitivity is also a path to higher spatial resolution (One can now apply lower amplitudes—not possible when the sensitivity is too low, as in conventional MFM—and lower lift heights, the volume of interaction becomes smaller, and hereby improves spatial resolution).
Correlated electrical/mechanical or magnetic/mechanical

Observation of small magnetic objects sensitive to the stray field of the tip.

Although the best mode contemplated by the inventors of carrying out the present invention is disclosed above, practice of the above invention is not limited thereto. It will be manifest that various additions, modifications and rearrangements of the features of the present invention may be made without deviating from the spirit and the scope of the underlying inventive concept.

We claim:

1. A method for measuring multiple properties of a sample, the method comprising:
providing an atomic force microscope (AFM) including a probe having a tip;
operating the AFM in an oscillating force mapping mode to cause the probe to oscillate and interact with the sample in one of a one pass procedure and a two pass procedure;
obtaining topographic and mechanical property data corresponding to the sample by detecting at least one characteristic of oscillation of the probe; and
collecting at least one of magnetic property data and electrical property data corresponding to the sample with the probe using at least one of an EFM algorithm and an MFM algorithm that includes driving one of the probe and sample to excite an oscillation of the probe.

2. The method of claim 1, wherein the force mapping mode is Peak Force Tapping mode.

3. The method of claim 1, wherein the algorithm includes gating detection of the probe oscillation.

4. The method of claim 3, wherein the gating step is performed at a hold position of tip-sample separation.

5. The method of claim 4, wherein the hold position corresponds to zero probe-sample separation.

6. The method of claim 3, wherein the excited oscillation is provided by a source of mechanical excitation at a resonance of the probe.

7. The method of claim 1, wherein the probe has a sensitivity factor (Q/k) greater than 40.

8. The method of claim 1, wherein a combination of a cantilever of the probe and the tip is made of a single homogeneous material.

9. The method of claim 1, wherein the tip has multiple sides, and less than all of the sides has a magnetic coating.

10. The method of claim 9, wherein the magnetic coating includes a Co—Cr coating.

11. A method for measuring multiple properties of a sample, the method including:
providing an atomic force microscope (AFM) including a probe having a cantilever and a tip, wherein the tip is at least one of magnetically and electrically active;
operating the AFM to cause the probe to interact with the sample in a two pass procedure;
detecting, during a first pass of the two pass procedure, a surface of the sample by operating the AFM in a force mapping mode; and
collecting, during a second pass of the two pass procedure, at least one of magnetic and electrical property data corresponding to the sample with the probe having a magnetic tip.

12. The method of claim 11, further comprising acquiring at least one of topography and mechanical property data during the detecting step.

13. The method of claim 12, wherein the acquiring step includes collecting mechanical property data and the mechanical property data includes at least one of elasticity, stiffness, plasticity, adhesion, viscoelasticity and hardness.

14. The method of claim 11, wherein the second pass uses gated detection of the oscillation of the probe.

15. The method of claim 14, wherein the gated detection is detection performed during the approach and snap-to-contact portion of the tip-sample force curve.

16. The method of claim 11, wherein the probe has a sensitivity factor (Q/k) greater than 40.

17. The method of claim 11, wherein the tip is magnetic.

18. The method of claim 17, wherein a magnetic Co—Cr coating is disposed on the tip.

19. The method of claim 11, wherein the force mapping mode is peak force tapping (PFT) mode.

20. An atomic force microscope (AFM) for performing magnetic force microscopy, the AFM comprising:
a probe having a tip, wherein the tip is one of a group including a) entirely magnetic, and b) coated with a magnetic material on at least one of a plurality of sides of the tip;
a scanner that provides relative scanning motion between the probe and a sample causing the probe to interact with the sample; and
a controller that controls the AFM in an oscillating force mapping mode to collect at least one of topography data and mechanical property data, and to collect at least one of magnetic data and electric property data with the probe using one of a group including a single pass procedure and a two pass procedure.
